(19) United States
(12) Patent Application Publication
(10) Pub. No.: US 2006/0157334 A1
(43) Pub. Date: Jul. 20, 2006

(54) Pressure activated interface

(75) Inventors: George Marmaropoulos, Yorktown Heights, NY (US); Giang Vu, New York, NY (US); Katharine Pulford, Hackney (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/560,708

(22) PCT Filed: Jun. 25, 2004
(86) PCT No.: PCT/IB04/51015

§ 371 Date: Dec. 15, 2005

Related U.S. Application Data
(60) Provisional application No. 60/483,773, filed on Jun. 30, 2003.

(51) Int. Cl. H01H 1/10

(52) U.S. Cl. 200/514; 200/512

(57) ABSTRACT

There is provided a flexible, lightweight high-performance pressure activated interface (1) that can cooperate with a variety of different textiles as well as with any of a variety of different electronic devices/systems without compromising characteristics of the different textiles. The interface (1) having a textile construction with one or more collapsible cavities (10). The collapsible cavities (10) having one or more conductive contact areas (30) associated with one or more leads (20) and situated such that at least two of the one or more conductive contact areas (30) can electrically communicate via a mechanical interaction. The at least two of the one or more conductive contact areas (30) being elevated relative to the one or more leads (20).

The present invention relates to textile electronics. More particularly, the present invention relates to an interface having one or more pressure activated switches preferably integrated into a flexible fiber construction. The pressure activated interface is preferably operative via a mechanical interaction and functional in various electronic applications and/or operations.

The use of electronics in various manufactured materials is well known; see for example, U.S. Pat. Nos. 6,360,615 B1, 6,210,771 B1, and 5,371,326; U.S. Patent Application Publication No. 2002/0135457 A1; PCT International Patent Publication Nos. WO 02/055923 A1 and WO 02/32665 A1; and/or UK Patent Application No. GB 2 373 863. Devices such as conductive traces, bio-sensors, electrodes, computers, electronic circuits and the like have all been incorporated into textiles. As the benefits associated with the various types and/or configurations of textile electronics become more apparent, the desirability and need for simple, effective and efficient, as well as intuitive user interface solutions becomes more apparent. Hence, there is a need for an input device or interface that is complementary to the various electronic functions/systems provided by the different textile electronics and/or the materials accommodating such electronics.

It is an object of the present invention to provide an interface suitable to address the above-identified need for simple, effective and efficient, as well as intuitive user interface solutions.

It is another object of the present invention to provide such an interface that has a flexible textile construction.

It is another object of the present invention to provide such an interface having one or more switches and corresponding interface graphics.

It is another object of the present invention to provide such an interface having one or more switches easily manufactured using conventional textile fabrication methods.

It is another object of the present invention to provide such an interface that is cooperative with a garment and/or one or more textile electronic devices or equipment.

It is another object of the present invention to provide such an interface operatively connectable or cooperative with a variety of electronic devices/systems.

It is still another object of the present invention to provide such an interface for accomplishing a variety of different electronic operations or functions.

These and other objects and advantages of the present invention are achieved by an interface having a textile construction with one or more collapsible spaces or cavities therein. The one or more collapsible cavities are preferably fashioned so as to be raised or elevated from the surface of the textile interface. Preferably, one or more strips or leads have one or more conductive contact areas associated therewith and cooperative with the textile interface such that at least two of the one or more conductive contact areas can electrically communicate via a mechanical interaction.

This mechanical interaction preferably causes the at least two conductive areas to be in conductive communication and thereby close one or more circuits or switches, which switch can in turn actuate an associated electronic function/operation. Thus, the interface of the present invention preferably facilitates accomplishing one or more intuitive electronic functions/operations. The intuitive interface is preferably in parallel with the properties or characteristics of the textile construction. Also, one or more switches of the textile interface can be made to be impermeable should waterproofing and/or insulating be required for a particular interface solution.

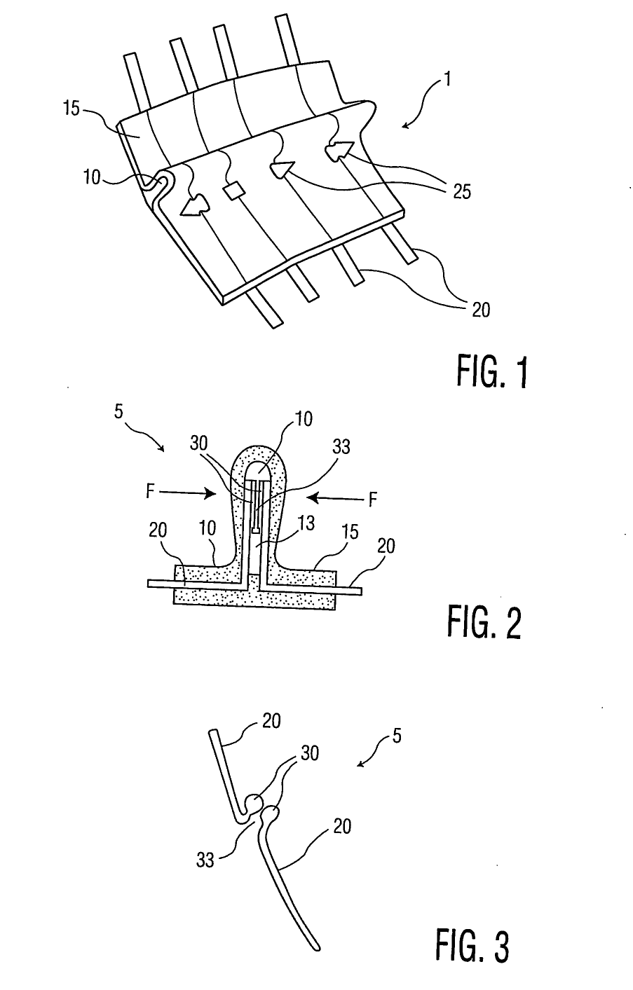

FIG. 1 is a perspective view of a pressure activated interface in accordance with an illustrative embodiment of the present invention;

FIG. 2 is a section view of a switch in accordance with an illustrative embodiment of the present invention;

FIG. 3 is a perspective view of a pair of leads in accordance with an illustrative embodiment of the present invention;

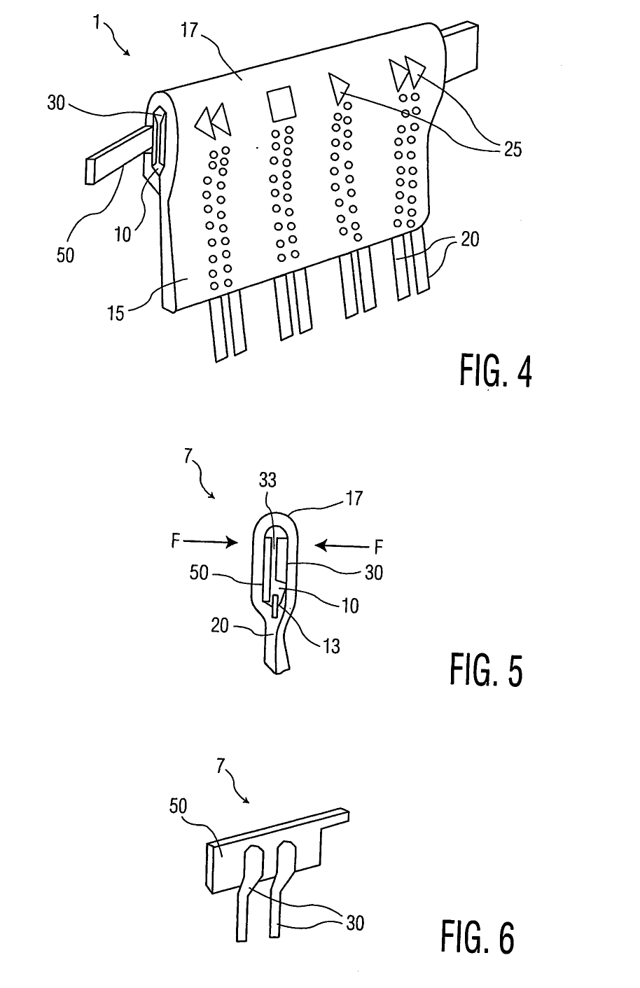

FIG. 4 is a perspective view of an interface in accordance with another illustrative embodiment of the present invention;

FIG. 5 is a perspective view one or more leads in accordance with another illustrative embodiment of the present invention; and

FIG. 6 is a section view of a switch in accordance with another illustrative embodiment of the present invention; and

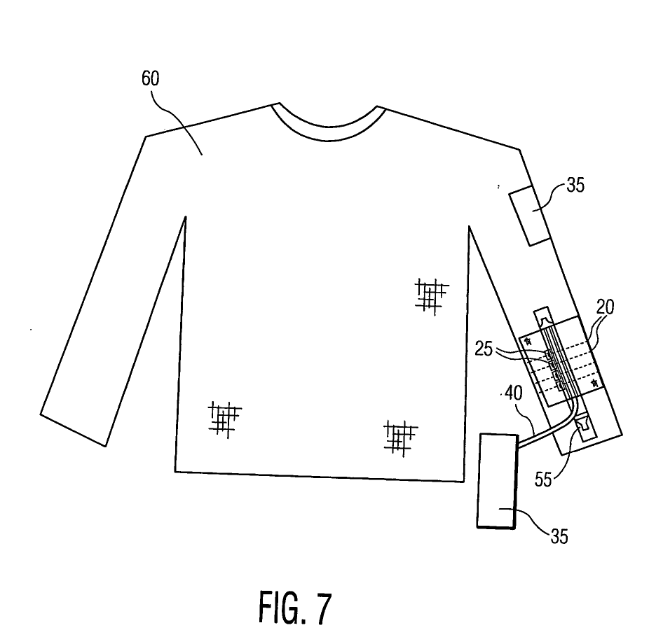

FIG. 7 is a front view of a garment incorporating the pressure activated interface of FIG. 1.

Referring to the drawings and, in particular, FIG. 1, a textile mesh or construction in accordance with an illustrative embodiment of the interface present invention is shown and generally represented by reference numeral 1. Preferably, textile construction or interface 1 has one or more collapsible spaces or cavities 10. The one or more collapsible cavities 10 are preferably fashioned to be elevated or raised from a surface 15 of the textile construction or interface 1. The textile interface 1 being integral with and/or cooperative with one or more other textiles, such as for example, those used in garments or upholstery. The textile interface 1 preferably also has one or more strips or leads 20 cooperative therewith. Interface graphics 25 can also be patterned or printed on the textile interface 1 so as to be associated with the one or more collapsible cavities 10. Preferably, the interface graphics 25 are suitable for easing user interpretation of various functions/operations associated with various types of textile electronics and like devices. It is noted that the interface graphics 25 can be either part of and/or integral with an abstract or decorative pattern associated with a textile.

Referring to FIGS. 1 and 2, the one or more collapsible cavities 10 are preferably integral with the textile interface 1. However, the one or more collapsible cavities 10 may also be separately connectable with the textile interface 1 via any known method/process for accomplishing such a task. The one or more collapsible cavities 10 may be fashioned from any suitable material, natural and/or manmade. For example, the one or more collapsible cavities 10 can be formed from a plasticized fiber or material to provide rigidity. Also, the one or more collapsible cavities 10 may be reinforced with a support or base element 13 which can preferably be injection molded to provide improved strength and support. Other configurations and/or arrangements may also be used in forming the textile interface 1 and/or the one or more collapsible cavities 10 thereof.

Referring to FIGS. 2 and 3, the one or more leads 20 are preferably elongated strips of at least one flexible fiber, cable and/or wire having one or more conductive contact areas 30 associated therewith. The one or more leads 20 can be formed from any material, natural and/or manmade, suitable to provide sufficient flexibility and durability to withstand the stresses associated with the manufacture and/or the handling thereof. Examples of such materials include, flexible metal coated materials including woven, non-wovens, and/or knits, filaments, foils, and yarns, conductive polymer coated fibers/materials, conductive graphitized materials, and/or conductive gel coated materials.

The one or more leads 20 and/or the one or more conductive contact areas 30 can be operative to facilitate electrical communication between and/or among various electronic devices, systems and/or power sources 35 via the textile interface 1. A connector 40 preferably can also be used to provide a medium for electrical communication between various electronic devices, systems, and/or power sources 35 and the textile interface 1. The connector 40 can have any configuration suitable to provide the effective means of electrical communication.

Referring to FIG. 2, the one or more conductive contact areas 30 are preferably in the one or more collapsible cavities 10 so as to be raised relative to the surface 15 of the textile interface 1 and have a fluid space 33 therebetween. The one or more leads 20 and/or the one or more conductive contact areas 30 thereof are preferably biased apart so that the one or more conductive contact areas 30 are innately disconnected. The bias of the one or more leads 20 and/or the one or more conductive contact areas 30 may be overcome via a mechanical interaction, such as for example, a force (F) being applied as shown in FIG. 2. The mechanical interaction can be either directly or indirectly applied by a user. Preferably, the mechanical interaction causes the one or more collapsible cavities 10 to collapse and the one or more conductive contact areas 30 to be connected or in conductive communication to close one or more circuits or switches 5.

Referring to FIGS. 4 through 6, in an alternative illustrative embodiment the one or more collapsible cavities 10 are preferably fashioned along the edge or perimeter 17 of the textile interface 1. The textile interface 1 being integral with and/or cooperative with one or more other textiles, such as for example, those used in garments or upholstery. The one or more collapsible cavities 10 in this alternative embodiment preferably have at least some, if not all, of the elements and/or features previously identified and discussed with respect to the foregoing embodiment. However, in this embodiment the one or more leads 20 and/or the one or more conductive contact areas 30 preferably cooperate with a conductive plane 50 to accomplish the electrical communication between the one or more conductive contact areas 30 and the closing of the one or more circuits or switches 7, which in turn can bring about an associated electronic operation/function.

Having described some of the preferred characteristics of the present invention, the method or process of forming a pressure activated user interface preferably includes at least the following steps. Fashioning a textile mesh or construction 1 having one or more user intuitive interface graphics 25 by any known method for accomplishing such construction (e.g., sewing, knitting and/or weaving). Either simultaneously or subsequently to the fashioning of the textile construction 1, fashioning one or more collapsible cavities 10 with one or more conductive contact areas 30 situated therein. Either simultaneously or subsequently to the fashioning of the one or more collapsible cavities 30, providing rigidity or reinforcement to the one or more collapsible cavities 30.

It is noted that the one or more conductive contact areas 30, additionally and/or alternatively to being associated with the one or more leads 20, may also be fashioned from a conductive material directly on the underside of the textile interface 1 in the one or more collapsible cavities 10 such that when a mechanical interaction (e.g., force F) is applied the one or more conductive contact areas 30 are brought together to be in electrical communication and/or to close a switch or circuit. Also, the textile interface 1 can have one or more securing mechanisms 55, such as that shown if FIG. 7, for selectively holding said one or more collapsible cavities 10 closed.

It is further noted that the one or more collapsible cavities 10 and/or the fluid space 33 may be at least partially filled with a gas, liquid and/or semi-liquid material or substance suitable for providing support and/or any other desired characteristic to the one or more collapsible cavities 10 and for allowing the one or more collapsible cavities 10 to collapse or close the fluid space 33 such that the one or more conductive contact areas 30 are brought into electrical communication.

It is still further noted that the one or more collapsible cavities 10 and/or the entire textile interface 1 can be made sufficiently impermeable to accomplish any waterproofing and/or insulating required for any of a variety of desired interface solutions.

Thus, the textile interface 1 preferably has properties suitable to provide sufficient flexibility and durability to withstand the stresses associated with manufacture and handling thereof. Thus, the interface 1 is preferably a highly flexible/resilient, lightweight high-performance intuitive user interface cooperative with various different textile electronics that can be integral with and/or connected to different textiles, such as a garment 60 as shown in FIG. 7, without compromising the innate characteristics of such textiles.

The present invention having been thus described with particular reference to the preferred forms thereof, it will be obvious that various changes and modifications may be made therein without departing from the spirit of the present invention as defined herein.

What is claimed is:

1. A pressure activated interface 1, comprising:
a textile construction having one or more collapsible cavities (10) and one or more conductive contact areas (30) associated with one or more leads (20),
wherein at least two of said one or more conductive contact areas (30) are in said one or more collapsible cavities (10) and are elevated relative to said one or more leads (20).

2. The interface (1) of claim 1, wherein the at least two of said one or more conductive areas (30) in said one or more collapsible cavities (10) are biased apart.

3. The interface (1) of claim 2, wherein said bias can be overcome a mechanical interaction.

4. The interface (1) of claim 3, wherein said mechanical interaction causes said one or more collapsible cavities (10) to be collapsed and said at least two of said one or more conductive contact areas (30) to be connected or in conductive communication to close a switch (5).

5. The interface (1) of claim 4, wherein said switch (5) is cooperative with any of a variety of electronic devices and/or is incorporable in a garment or upholstery (60).

6. The interface 1 of claim 1, further comprising one or more interface graphics (25) associated with the one or more collapsible cavities (10).

7. The interface (1) of claim 1, wherein said one or more collapsible cavities (10) are fashioned a relatively rigid material.

8. The interface (1) of claim 1, wherein said one or more collapsible cavities (10) are reinforced via a support element (13).

9. The interface (1) of claim 8, wherein said support element (13) is injection molded to provide support to said one or more collapsible cavities (10).

10. The interface (1) of claim 1, wherein the interface (1) is formed using any conventional textile fabrication method.

11. The interface (1) of claim 1, wherein said one or more conductive contact areas (30) are fashioned from said one or more leads (20).

12. The interface (1) of claim 11, wherein said one or more leads (20) are integral with said one or more collapsible cavities (10).

13. The interface (1) of claim 1, further comprising one or more securing mechanisms (55) for selectively holding said one or more collapsible cavities (10) closed.

14. A method for forming a pressure activated interface (1) comprising the steps of:
fashioning a textile construction (1) having one or more user intuitive interface graphics (25) patterned thereon;
simultaneously or subsequently fashioning one or more collapsible cavities 10 with one or more conductive contact areas (30) therein; and
simultaneously or subsequently providing said one or more collapsible cavities (10) with reinforcement.

15. The method of claim 14, wherein said one or more collapsible cavities (10) and said one or more conductive contact areas (30) are raised to accommodate a mechanical interaction.

16. The method of claim 14, wherein said one or more conductive contact areas (30) are associated with one or more leads (20), which in turn are operatively connectable with any of a variety of electronic devices and/or systems.

17. The method of claim 14, further comprising the step of incorporating said interface (1) into a garment (60).

18. A flexible interface (1) comprising:
a textile construction with one or more collapsible cavities (10) along an edge or perimeter (17) thereof;
a conductive plane (31) in said one or more raised collapsible cavities (10); and
one or more leads (20) with one or more conductive contact areas (30) conductively cooperative with said conductive plane (31) in response to a mechanical interaction.

19. The interface (1) of claim 18, wherein said mechanical interaction causes the collapse of said collapsible cavities (10) thereby bringing said conductive plane (31) and said one or more conductive contact areas (30) into conductive communication to close a switch (5), said switch (5) being cooperative with any of a variety of electronic devices and/or is incorporable in a garment or upholstery (60).
